(19) United States
(12) Patent Application Publication
(10) Pub. No.: US 2017/0249875 A1
(43) Pub. Date: Aug. 31, 2017

(54) SECURITY ELEMENT WITH COLOR SHIFT EFFECT AND MANIPULATION DETECTION

(71) Applicant: HUECK FOLIEN GES.M.B.H., Baumgartenberg (AT)

(72) Inventors: Marco MAYRHOFER, Sierning (AT); Georg AIGNER, Pabneukirchen (AT)

(73) Assignee: HUECK FOLIEN GES.M.B.H., Baumgartenberg (AT)

(21) Appl. No.: 15/310,153

(22) PCT Filed: Apr. 20, 2015
(86) PCT No.: PCT/EP2015/000823

§ 371 Date: Nov. 10, 2016

(30) Foreign Application Priority Data
Jul. 17, 2014 (AT) A 565/2014

(51) Int. Cl. G09F 3/00; C09J 7/02; G02B 5/18; G03H 1/00; G09F 3/10; G09F 3/03

(52) U.S. Cl. CPC G09F 3/0292; G09F 3/10; G09F 3/0341; G02B 5/1828; G03H 1/0011; G02B 5/1814; C09J 7/02; G09F 2003/0257

(57) ABSTRACT

The invention relates to a security element with manipulation detection, in particular a security label or a transferable element, having the following layers: a) a first layer which is an embossed support substrate or a support substrate (1) with a coating layer (6) that has an optically active structure (7) or a first liquid crystal layer, b) a second layer which is a liquid crystal layer (3), c) a light-absorbing layer (4), and d) an adhesive layer (5), wherein the adhesion between the layers a. and b. is lower than the adhesion between the layers b., c., and d., and the security element has a color shift effect.

The present invention relates to a tamper-evident security element, more particularly a tamper-evident security label.

The present invention more particularly relates to security elements comprising a color tilt effect and a further security feature which is non-discernible in the intact state and only becomes discernible after a tampering attempt.

WO 01/93231 A discloses a safety label comprising two microstructures whereof one is a diffractive structure discernible even in the untampered state and the other is a release-controlling structure. A tampering attempt will detach at least parts of a reflective layer to reveal a new visually discernible message.

EP 2 234 091 A discloses a safety label comprising an optically active structure which is non-visible in the intact state and only becomes discernible after a tampering attempt.

The problem addressed by the present invention was that of providing a tamper-evident security element, more particularly a tamper-evident security label, wherein the security label by way of a security feature comprises a color tilt effect and an additional security feature which is only discernible on tampering and is non-discernible in the untampered state.

The security element shall further comprise in the tampered state a smooth non-tacky surface on both surfaces.

The invention accordingly provides a tamper-evident security element, more particularly a security label and/or a transferable element, characterized in that it comprises the following layers:
a. a first layer representing a full-arealy or partially embossed supporting substrate 8 or a supporting substrate 1 comprising a full-areal or partial lacquer layer 6 comprising an optically active structure 7 or a full-areal or partial first liquid-crystalline layer 2,
b. a second layer representing a liquid-crystalline layer 3,
c. optionally a light-absorbing layer 4,
d. an adhesive coating 5,
   wherein the adherence between the layers a. and b. is lower than the adherence between the layers b. c. and d. and wherein the security element comprises a color tilt effect.

The first layer may be an embossed supporting substrate or a supporting substrate comprising a lacquer layer comprising an optically active structure or a first liquid-crystalline layer.

Useful embossed supporting substrates include, for example, hot-embossed foils or replication-lacquer layers, where the replication-lacquer layer may be radiatively curable or physically curable.

Useful supporting substrates include, for example, supporting sheets, preferably flexible polymeric sheets, for example in PI, PP, MOPP, PE, PPS, PEEK, PEK, PEI, PSU, PAEK, LCP, PEN, PBT, PET, PA, PC, COC, POM, ABS, PVC, fluoropolymers, such as Teflon and the like. Supporting sheets are preferably 5-700 μm, more preferably 5-200 μm, yet more preferably 5-100 μm in thickness.

Useful supporting substrates further also include coextruded or chemically or physically pretreated polymeric sheets, for example acrylate-coated polymeric sheets.

The supporting substrate may optionally have a coating of adhesion promoter.

Optionally, orientation layers may also be provided in order to amplify the effect of the layer composed of liquid-crystalline material.

A first layer of lacquer or a first layer of a liquid-crystalline material is applied atop the supporting substrate.

This first layer of lacquer may be a radiatively curable layer of lacquer or a thermoplastic layer of lacquer, and comprises an optically active structure.

The radiatively curable lacquer may be, for example, a radiatively curable lacquer system based on a polyester, epoxy or polyurethane system containing two or more different photoinitiators familiar to a person skilled in the art which are capable of initiating a curing reaction of the lacquer system at different wavelengths to a differing degree. For instance, one photoinitiator may be activable at a wavelength of 200 to 400 nm, while the second photoinitiator is then activable at a wavelength of 370 to 600 nm. Sufficient difference should be maintained between the activation wavelengths of the two photoinitiators in order not to excessively excite the second photoinitiator while the first photoinitiator is being activated. The region in which the second photoinitiator is excited should be in the transmission wavelength region of the supporting substrate used. The main cure (activation of the second photoinitiator) may also employ electron beam radiation.

The radiatively curable lacquer used may also be a water-thinnable lacquer. Polyester-based lacquer systems are preferred.

The surface structure, i.e., the diffractive, diffusive or relief structure, is molded, for example under temperature control, with a female mold or by using an embossing mold, into the radiatively curable lacquer layer which, by activating the first photoinitiator, has been pre-cured to the gel point and has remained in that state up to the time of molding.

When a water-thinnable radiatively curable lacquer is used, predrying, for example with IR radiators, may optionally be carried out first.

The thermoplastic lacquer which is subsequently stabilized consists of a base of MMA or ethylcellulose or cycloolefin copolymer, while modifiers are added to the base polymer for the purpose of establishing the required thermoplastic properties and/or for the purpose of establishing the subsequent stabilizability.

Useful modifiers depend on the base polymer and include, for example, additives for establishing the desired glass transition temperature, the domain in which the lacquer is in a thermoplastic state, or modifiers to achieve durable curing of the lacquer.

The components are preferably dissolved in a solvent, for example in aqueous solvents, water, alcohols, ethyl acetate, methyl ethyl ketone and the like or mixtures thereof.

Nitrocellulose, for example, is added to an MMA-based lacquer to particular advantage for the purpose of raising the glass transition temperature.

Polyethylene waxes, for example, are added to particular advantage to a lacquer based on cycloolefin copolymers.

Commercially available crosslinkers are added to an ethylcellulose-based lacquer for the purpose of establishing curability.

The concentration of base polymer in the final lacquer is 4-50%, depending on the base polymer, on the desired properties of the lacquer and on modifier type and concentration.

A conventional thermal method of embossing is employable to effect patterning.

The layer thickness of the lacquer applied may vary according to the requirements of the end product and substrate thickness, generally being between 0.5 and 50 μm, preferably between 2 and 10 μm, more preferably between 2 and 5 μm.

An optically active structure within the meaning of the present invention is more particularly a diffraction-optically active structure, such as a hologram, a surface relief, a diffraction structure, a diffraction grating, a kinegram or an embossment 1-100 μm in depth, and the like.

The first layer may also be a first liquid-crystalline layer comprising an optically variable effect. This liquid-crystalline layer may also consist of a printing ink containing pigments composed of liquid-crystalline material. The pigments more particularly consist of cholesteric liquid crystals or of a mixture of nematic and cholesteric liquid crystals.

The first layer subsequently has applied to it a second layer of a (further) liquid-crystalline material.

When the first layer comprises a lacquer layer comprising an optically active structure or comprises an embossed supporting substrate, this liquid-crystalline layer will conform to the structure of the optically active layer, the liquid crystals undergo orientation in these structures, the result being a color tilt effect. The optically active effect is non-discernible.

When the first layer consists of a first liquid-crystalline layer, the second liquid-crystalline layer preferably comprises a different hue than the first liquid-crystalline layer.

An optionally light-absorbing layer is applied as a further layer c. This light-absorbing layer may be applied full-arealy or partially.

This layer is formable either from a light-absorbing printing ink, preferably a printing ink incorporating dark or black pigments or a light-absorbing metallic coating.

Astoichiometric alumina and stoichiometric or astoichiometric copper oxide are preferred candidates for the light-absorbing metallic layer. The light-absorbing metallic layer preferably has a dark to black coloration. The stronger the absorption of the background in the visible spectrum (350-800 nm), the stronger the visible optically variable effect.

The light-absorbing layer may optionally be replaced by a dark background on the article to be secured or by a corresponding colored adhesive coating.

This set-up has an adhesive coating applied to it, preferably a self-adhesive coating, a contact-adhesive coating or a heat-sealable adhesive coating.

This adhesive coating fixes the security element on the article to be secured.

When a self-adhesive coating or a cold-sealable coating is used to apply the set-up to the object to be secured, the adherence between the layers a. and b. has to be lower than the adherence between the layers b., c. and d., and also lower than the adherence of the adhesive layer on the object to be secured.

The adherence between the layers a. and b. is engineerable between wide limits by surface treatment of layer a. Suitable methods of surface treatment include, for example, physical or chemical surface treatment, plasma (low pressure or atmospheric plasma), corona and/or flame pretreatment or printed pretreatment.

In a further embodiment, a badly adherent layer of lacquer may alternatively be introduced between layer a. and layer b., examples being badly adherent layers based on cycloolefin copolymers, nitrocellulose, acrylates, polyvinyl chloride, ethylene-acrylate copolymers or styrene acrylates. It is preferably chlorinated polyolefins which are added to engineer the adherence. The proportion of chlorinated polyolefins in the composition may be from 0 to 130 wt % relative to the base polymer.

It is alternatively possible to use any desired lacquer systems whose adherence is reduced by an additive, e.g., Byk 394®.

The badly adherent layer of lacquer evinces better adherence to layer b. than to layer a. A tampering attempt will then cause the set-up to separate between layer a. and the badly adherent layer of lacquer.

The security element exhibits a color tilt effect in the intact state. Where the first layer consists of a full-arealy or partially embossed supporting substrate or of a supporting substrate comprising a full-areal or partial lacquer layer comprising an optically active structure, the hue and/or the color tilt effect corresponds to the color tilt effect of the layer composed of a liquid-crystalline material b. Where the first layer consists of a first liquid-crystalline material, the hue and/or color tilt effect corresponds to a mixed color of the color tilt effects of the two liquid-crystalline layers.

A tampering attempt, in particular the attempt to peel the sheet and/or label off the object to be secured, will separate the first layer a. from the second layer b.

When the first layer consists of a full-arealy or partially embossed supporting substrate or of a supporting substrate comprising a full-areal or partial lacquer layer comprising an optically active structure, the tampering attempt will reveal the initially non-discernible optically active structure as a positive in the first (removed) layer and as a negative in the second layer (remaining behind on the object to be secured) of liquid-crystalline material.

When the first layer consists of a layer of a first liquid-crystalline material, a tampering attempt will reveal, in the background to be secured, the hue and/or the color tilt effect of the second liquid-crystalline layer, this hue and/or color tilt effect differing from that of the intact security element.

When the security element is in the form of a transfer element applied to the article to be secured, authentication is possible by ancillary means, for example by means of the so-called Tesa test. To this end, an adhesive strip is applied to the security element and subsequently peeled off. The optically active structure incorporated in the first lacquer layer becomes discernible not only as a positive in the lacquer layer remaining on the adhesive strip but also as a negative in the lacquer layer remaining on the object to be secured.

In addition, the surface of the lacquer layer remaining on the article to be secured is dry and non-tacky to the touch (“dry peel effect”), as is the surface of the part peeled off.

The security element of the present invention may be applied as a security element to packaging materials or be used in fabricated form as labels in any desired shape (angular, round, oval) or as adhesive tape to secure articles or packaging.

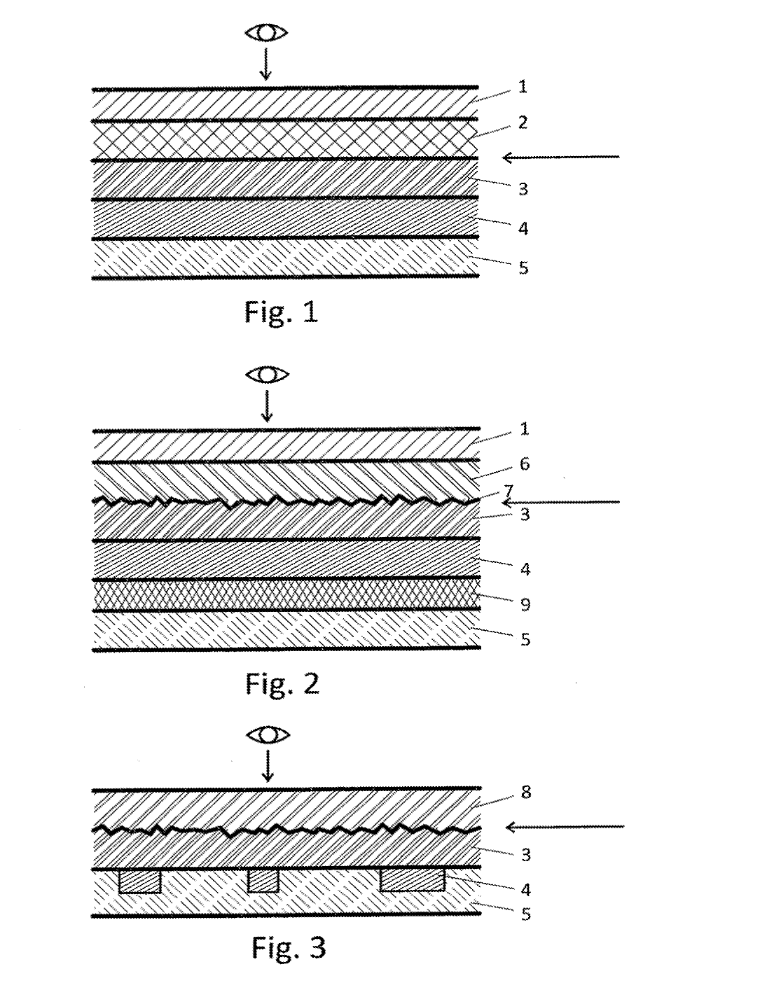

FIGS. 1 to 7 depict exemplary embodiments of the security element according to the present invention.

In the figures,

1 denotes a supporting substrate

2 denotes a layer of a first liquid-crystalline material,

3 denotes a layer of a (second) liquid-crystalline material,

4 denotes a light-absorbing layer,

5 denotes an adhesive coating,

6 denotes a lacquer layer,

7 denotes an optically active structure,

8 denotes an embossed supporting substrate,

9 denotes a primer layer.

FIG. 1 shows a security element comprising a supporting substrate 1 provided a first layer of liquid-crystalline material 2. Atop this first layer of a first liquid-crystalline material 2 is a second layer of a second different liquid-crystalline material 3.

The light-absorbing layer 4 in this example consists of a black printed layer. A self-adhesive coating 5 may be used to fix the security element on the object to be secured. A superimposed color tilt effect of the two layers 2 and 3 is discernible on inspection.

A tampering attempt will cause the first liquid-crystalline layer 2 to separate from the second liquid-crystalline layer 3, since the adherence between these two layers has been engineered to be weaker than the adherence between the remaining layers.

A tampering attempt will reveal, in the background to be secured, the hue and/or the color tilt effect of the second liquid-crystalline layer 3, this hue and/or color tilt effect differing from that of the intact security element.

In FIG. 2, a lacquer layer 6 comprising an optically active structure 7 is provided in place of the first liquid-crystalline layer. The light-absorbing layer 4 is formed of a coating of astoichiometric alumina. This light-absorbing layer 4 is subsequently provided a primer layer 9. To fix the security element on the article to be secured, a heat-sealing lacquer coating is provided as adhesive coating 5.

The optically active effect is non-discernible in the intact state provided the refractive index of lacquer layer 6 has been conformed to the refractive index of layer 3 of liquid-crystalline material. However, the color tilt effect due to layer 3 is discernible. A tampering attempt will cause the optically active structure to separate from the layer of liquid-crystalline material 3, revealing the optically active structure not only as a positive in the first (removed) layer but also as a negative in the second layer (remaining behind on the object to be secured) of liquid-crystalline material.

In FIG. 3, a layer of a liquid-crystalline material 3 has been applied atop an embossed supporting substrate, for example a hot-embossed sheet 8. A partial metallic coating of astoichiometric copper oxide has been applied as light-absorbing layer 4.

The security element is fixed via a self-adhesive coating 5 to the object to be secured. A tampering attempt will cause the layer of liquid-crystalline material 3 to separate from the hot-embossed sheet 8.

The optically active effect is non-discernible in the intact state provided the refractive index of hot-embossed sheet 8 has been conformed to the refractive index of layer 3 of liquid-crystalline material. However, the color tilt effect due to layer 3 is discernible. A tampering attempt will cause the optically active structure to separate from the layer of liquid-crystalline material 3, revealing the optically active structure of the hot-embossed sheet not only as a positive in the first (removed) layer but also as a negative in the second layer (remaining behind on the object to be secured) of liquid-crystalline material.

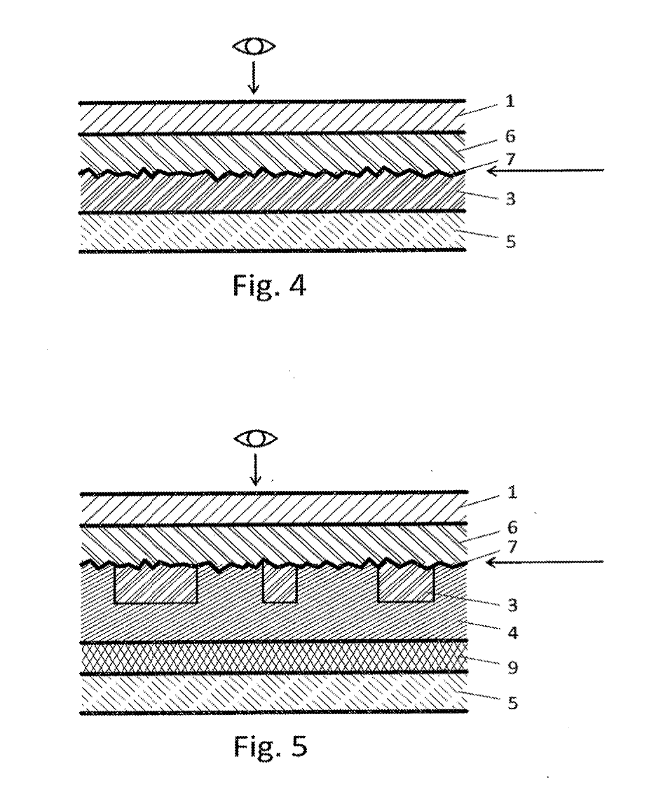

FIG. 4 depicts an embodiment constructed without a light-absorbing layer. In this case, the intensity of the visible color tilt effect is determined by the degree to which the article to be secured absorbs light.

The lower the light absorption of the background, the weaker the color tilt effect. In the event of a tampering attempt, a security element as per this embodiment behaves similarly to the security element depicted in FIG. 2.

The security element of FIG. 5 is constructed in a similar way to the security element depicted in FIG. 2, except for having a partial layer 3 of liquid-crystalline material.

The color tilt effect is partially discernible in the intact state. In the event of a tampering attempt, a security element as per this embodiment will behave essentially similarly to the security element depicted in FIG. 2. The layer of liquid-crystalline material will separate from the lacquer layer 6 comprising an optically active structure 7. The light-absorbing layer will remain behind on the layer 6 in those areas where there is no layer 3.

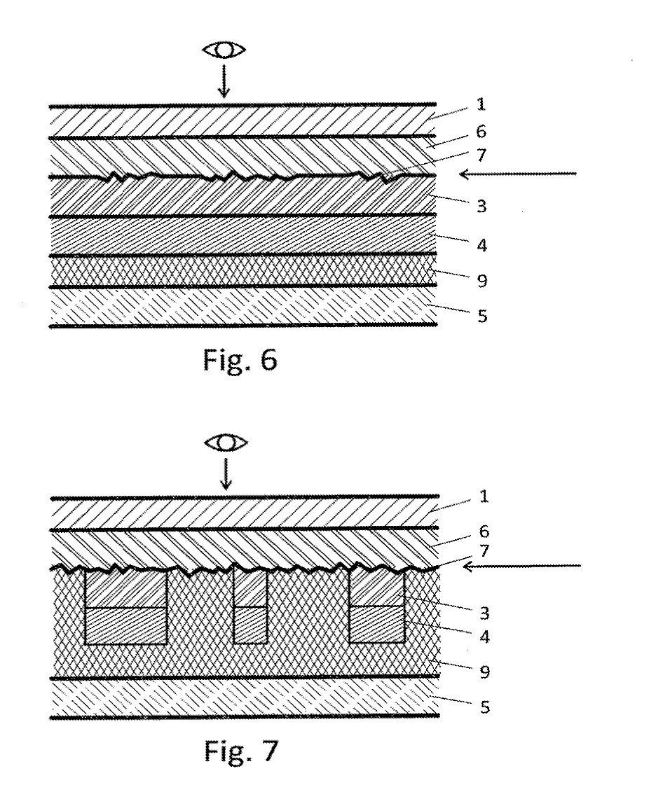

In the embodiment of FIG. 6, the lacquer layer 6 is provided a partial optically active structure.

This partial optically active effect is non-discernible in the intact state provided the refractive indices of lacquer layer 6 and of layer 3 have been conformed to each other. When the two refractive indices have not been conformed to each other, the optically active effect is discernible even in the intact state.

In the event of a tampering attempt the security element as per this embodiment will behave similarly to the security element depicted in FIG. 2. In a further embodiment, lacquer layer 6 may be provided in partial form as well as the optically active structure 7.

In the embodiment depicted in FIG. 7, both the layer of liquid-crystalline material 3 and the light-absorbing layer 4 are in partial form.

In this case, the color tilt effect is partially discernible not only in the intact state but also after a tampering attempt.

1-12. (canceled)

13. A tamper-evident security element, more particularly a security label and/or a transferable element, characterized in that it comprises the following layers:
a. a first layer representing a full-arealy or partially embossed supporting substrate 8 or a supporting substrate 1 comprising a full-areal or partial lacquer layer 6 comprising an optically active structure 7 or a full-areal or partial first liquid-crystalline layer 2,
b. a second layer representing a liquid-crystalline layer 3,
c. optionally a light-absorbing layer 4,
d. an adhesive coating 5,
wherein the adherence between the layers a. and b. is lower than the adherence between the layers b. c. and d. and wherein the security element comprises a color tilt effect.

14. The security element as claimed in claim 13, wherein the first layer represents a supporting substrate 1 comprising a lacquer layer 6 comprising an optically active structure 7 or a first liquid-crystalline layer 2, an adhesion promoter is provided between the supporting substrate 1 and the lacquer layer 6 or liquid-crystalline layer 2.

15. The security element as claimed in claim 13, wherein the adherence between the layers a. and b. is established by surface modification of the physical or chemical type.

16. The security element as claimed claim 13, wherein the optically active structure 7 is a diffraction-optically active structure, such as a hologram, a surface relief, a diffraction structure, a diffraction grating, a kinegram or an embossment 1-100 μm in depth.

17. The security element as claimed in claim 13, wherein the layer a. represents a first liquid-crystalline layer 2 applied atop a supporting substrate 1 the second liquid-crystalline layer 3 comprises a different hue and/or color tilt effect than the first liquid-crystalline layer 2.

18. The security element as claimed in claim 13, wherein the first lacquer layer 6 is a radiatively curable type of lacquer layer.

19. The security element as claimed in claim 13, wherein the first lacquer layer 6 is a thermoplastic type of lacquer layer.

20. The security element as claimed in claim 13, wherein the lacquer layer 6 or the first liquid-crystalline layer 2 or the liquid-crystalline layer 3 are engineered as partial layers.

21. The security element as claimed in claim 13, wherein the light-absorbing layer 4 is applied partially or full-arealy.

22. The security element as claimed in claim 13, wherein the light-absorbing layer 4 is formed by a light-absorbing printed layer or by a light-absorbing metallic coating.

23. The security element as claimed in claim 13, wherein the adhesive coating 5 is a self-adhesive coating, a cold-sealable coating or a heat-sealable coating.

24. The method of using the security element as claimed in claim 13 for security labels, adhesive tapes or security foils.
